(19) United States
(12) Patent Application Publication
(10) Pub. No.: US 2021/0389985 A1
(43) Pub. Date: Dec. 16, 2021

(54) DATA PROCESSING METHOD, ELECTRONIC DEVICE, AND STORAGE MEDIUM

(71) Applicant: HON HAI PRECISION INDUSTRY CO., LTD., New Taipei (TW)

(72) Inventor: WEN-RUEI CHEN, New Taipei (TW)

(21) Appl. No.: 17/344,102

(22) Filed: Jun. 10, 2021

(30) Foreign Application Priority Data
Jun. 12, 2020 (CN) 202010533951.0

(51) Int. Cl. G06F 9/48; G06F 12/0804

(52) U.S. Cl. CPC G06F 9/4887; G06F 2212/1016; G06F 12/0804

(57) ABSTRACT

A data processing method, an electronic device and a non-volatile storage medium are disclosed, the method includes selecting a next to be executed thread and determining whether the selected thread is a high-performance thread. If the selected thread is a high-performance thread and a thread-user of the on-chip memory is not the selected high-performance thread, contents of the on-chip memory are backed to a stack memory of a thread corresponding to the thread-user. Contents of a stack memory of the selected thread are backed to the on-chip memory. The thread-user of the on-chip memory is updated to indicate the selected thread. The contents of the on-chip memory in a CPU register is stored to complete the switching out; and the selected thread is executed. The present disclosure can accelerate and speed up data processing.

### FIELD

The present disclosure relates to a technical field of computer, specifically a data processing method, an electronic device and a storage medium.

### BACKGROUND

Most application microcontrollers must provide task switching and multithreading capabilities. When certain time-critical events, such as interruptions caused by timers, communication ports, or external circuits happen, the microprocessor must be stopped from continuing currently tasks, and be redirected to perform other higher priority tasks. Existing microcontrollers tend to slow down the processing speeds during real-time task switching and multi-thread processing.

### BRIEF DESCRIPTION OF THE DRAWINGS

FIG. 1 shows a flowchart of a data processing method provided in an embodiment of the present disclosure.

FIG. 2 shows a schematic structural diagram of a data processing system provided in an embodiment of the present disclosure.

FIG. 3 shows a schematic structural diagram of an electronic device provided in an embodiment of the present disclosure.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

A data processing method of the present disclosure can be applied to one or more electronic devices. The electronic device includes hardware such as, but not limited to, a microprocessor and an Application Specific Integrated Circuit (ASIC), Field-Programmable Gate Array (FPGA), Digital Signal Processor (DSP), embedded devices, etc.

The electronic device may be a device such as a desktop computer, a notebook, a palmtop computer, or a cloud server. The electronic device can interact with users through a keyboard, a mouse, a remote control, a touch panel, or a voice control device.

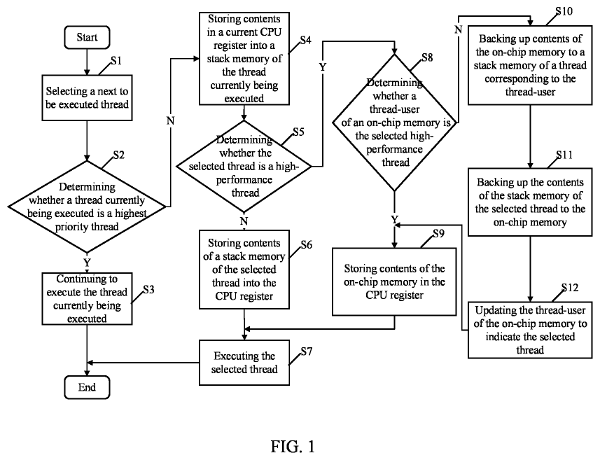

FIG. 1 is a flowchart of a data processing method in an embodiment of the present disclosure. The data processing method is applied to the electronic devices. According to different needs, the order of the steps in the flowchart can be changed, and some can be omitted.

In block S1, selecting a next to be executed thread.

In an embodiment, when an interrupt service is end or a system is called, a scheduler is started to schedule threads for execution of tasks, and the scheduler selects the next to be executed thread.

In block S2, determining whether a thread currently being executed is a highest priority thread. If the thread currently being executed is determined to be the highest priority thread, the flow proceeds to block S3. If the thread currently being executed is determined not the highest priority thread, the flow proceeds to block S4.

In a process of thread scheduling by the scheduler, the next to be executed thread can be selected according to priorities of the thread. The priorities can be set as a parameter available for scheduling by the scheduler. In an embodiment, by determining whether the thread currently being executed is the highest priority thread, it is determined whether the thread currently being executed is the selected thread. If the thread currently being executed is the highest priority thread, it is determined that the thread currently being executed is the selected thread, and the flow goes to block S3. If the thread currently being executed is not the highest priority thread, it is determined that the thread currently being executed is not the selected thread, and the flow goes to block S4.

In block S3, continuing to execute the thread currently being executed.

In an embodiment, if the thread currently being executed is not the highest priority thread, execution of the thread currently being executed continues.

In block S4, storing contents in a current CPU register into a stack memory of the thread currently being executed.

Since a task of the thread currently being executed may not be completed, it is necessary to save execution progress of the thread when switching later, so that it can continue to run when switching back later. To give a simple example: for example, a thread A is reading contents of a file, and it has read half of the file, at this time, thread A needs to be suspended, and thread B is executed. When it is switched back to execute thread A again, thread A should not read again from a beginning of the file. Therefore, the contents of the thread currently being executed needs to be saved.

When a thread is in a process of being switched, it is necessary to save an Id, a thread state, a stack, states of registers, and other information of the current thread. The registers mainly include an SP, a PC, and an EAX registers. The SP is a stack pointer, pointing to a top address of a current stack. The PC is a program counter, which stores a next instruction to be executed. The EAX is an accumulation register, a default register for addition and multiplication.

In an embodiment, the contents of the current CPU register includes the stack pointer and the states of registers.

In block S5, determining whether the selected thread is a high-performance thread. When the selected thread is not a high-performance thread, the process goes to block S6; when the selected thread is a high-performance thread, the process goes to block S8.

In an embodiment, one task may include a plurality of threads, and the plurality of threads may include a plurality of high-performance threads and some non-high-performance threads. A high-performance thread refers to a thread that accelerates local variable access during activities of the thread. Developers need to define which threads are high-performance threads during thread initialization. Specifically, when a thread is created, it is determined whether the created thread is a high-performance thread according to execution contents of the thread. When it is determined that the created thread is a high-performance thread, the created thread is marked as a high-performance thread, and the marked high-performance thread is added to a thread list. When it is determined that the created thread is a non-high-performance thread, the created thread is added to the thread list but is not marked.

In an embodiment, in determining whether the next to be executed thread is a high-performance thread, the selected thread is checked for a mark. If the selected thread has a mark, it is determined that the next to be executed thread is a high-performance thread. If the selected thread has no mark, it is determined that the next to be executed thread is a non-high-performance thread.

In block S6, storing contents of a stack memory of the selected thread into the CPU register.

When the selected thread is a non-high-performance thread, the contents of the selected thread (such as the PC, the SP, and the other registers, etc.) are copied from the stack memory of the selected thread to the CPU register, and the on-chip memory is switched out.

In block S7, executing the selected thread.

In this embodiment, when it is confirmed that the selected thread is not a high-performance thread, the thread currently being executed and the selected thread are switched, and the selected thread is executed after the switching is completed.

In block S8, determining whether a thread-user of an on-chip memory is the selected high-performance thread. When the thread-user of the on-chip memory is the selected high-performance thread, the process proceeds to block S9. When the thread-user of the on-chip memory is not the selected high-performance thread, the process proceeds to block S10.

In an embodiment, the thread-user of the on-chip memory refers to a target (for example, a thread) that is using the on-chip memory. When the selected thread is a high-performance thread, it is necessary to perform switching out of the selected thread through the on-chip memory. However, before switching, it is necessary to first determine whether the thread-user of the on-chip memory is the selected high-performance thread. That is to say, it is necessary to first determine whether the on-chip memory is being used by the selected high-performance thread.

In block S9, storing contents of the on-chip memory in the CPU register, and then the flow goes to block S7.

In an embodiment, when the thread-user of the on-chip memory is the selected high-performance thread (that is, the selected high-performance thread is using the on-chip memory), the contents of the on-chip memory are directly stored in the CPU register, the on-chip memory is switched out, and then the selected high-performance thread is executed.

In block S10, backing up contents of the on-chip memory to a stack memory of a thread corresponding to the thread-user.

In an embodiment, when the thread-user of the on-chip memory is not the selected high-performance thread, the contents of the on-chip memory needs to be backed up to the stack memory of the thread corresponding to the thread-user of the current on-chip memory. It should be noted that each thread has its own stack memory. In order to ensure that data is not lost, the contents of the on-chip memory needs to be backed up to the stack memory of the thread corresponding to the thread-user (the thread that is using the on-chip memory).

In block S11, backing up the contents of the stack memory of the selected thread to the on-chip memory.

In an embodiment, the on-chip memory is small and high-speed, and can be used as a stack memory shared by a plurality of threads. When the selected thread is a high-performance thread, the on-chip memory is required for execution, which can speed up data access. After the contents of the on-chip memory is backed up to the stack memory of the thread corresponding to the thread-user, the contents of the selected thread is loaded into the on-chip memory to process the selected thread through the on-chip memory thread.

In block S12, updating the thread-user of the on-chip memory to indicate the selected thread, and proceeding to block S9.

In an embodiment, after backing up the contents of the stack memory of the selected thread to the on-chip memory, it is also necessary to update the using of the on-chip memory by the selected thread. The contents of the on-chip memory is stored in the CPU register, the on-chip memory is switched out, and then the selected thread is executed.

In an embodiment, an occupancy parameter of the on-chip memory may be updated to a parameter corresponding to the selected thread.

In an embodiment, the on-chip memory includes an occupancy parameter, and the occupancy parameter corresponds to a thread. After the contents of the selected thread is loaded into the on-chip memory, the occupancy parameter of the on-chip memory is updated to the parameter corresponding to the selected thread to indicate that the on-chip memory is occupied by the selected thread.

For example, if the thread currently being executed C is a non-high-performance thread, and the next to be executed thread N is a high-performance thread, first determine whether the current thread-user P of the on-chip memory is a high-performance thread. If the current thread-user P of the on-chip memory is a high-performance thread, the contents of the on-chip memory needs to be stored in the CPU register, the on-chip memory is switched out. If the current thread-user P of the on-chip memory is a non-high-performance thread, the contents of the on-chip memory needs to be backed up to the stack memory of the thread corresponding to the thread-user P first. Then the contents of the stack memory of thread N is backed up to the on-chip memory, and the thread-user of the on-chip memory is updated to the thread N, and then the contents of the on-chip memory is stored in the CPU register, the on-chip memory is switched out. In this way, it is possible to select whether to execute the thread through the on-chip memory according to a type of thread. For example, when the type of thread is a high-performance thread, it can be executed through the on-chip memory. On-chip memory has a characteristic of high-speed processing, and this will accelerate and speed up data processing.

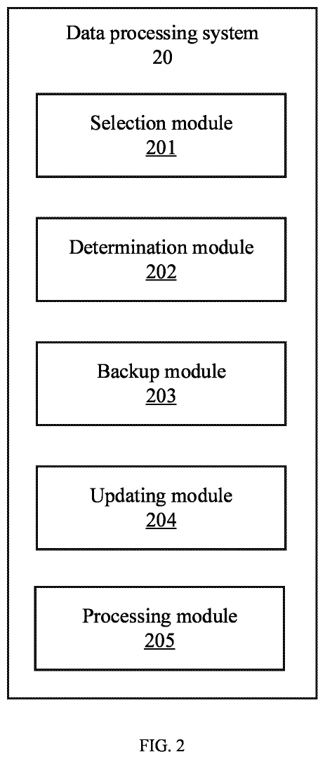

FIG. 2 shows a schematic structural diagram of a data processing system provided in the embodiment of the present disclosure.

In some embodiments, the data processing system 20 runs in an electronic device. The data processing system 20 can include a plurality of function modules consisting of program code segments. The program code of each program code segments in the data processing system 20 can be stored in a memory and executed by at least one processor to perform data processing (described in detail in FIG. 2).

As shown in FIG. 2, the data processing system 20 can include: a selection module 201, a determination module 202, a backup module 203, an updating module 204, and a processing module 205. A module as referred to in the present disclosure refers to a series of computer-readable instruction segments that can be executed by at least one processor and that are capable of performing fixed functions, which are stored in a memory. In some embodiment, the functions of each module will be detailed.

The above-mentioned integrated unit implemented in a form of software functional modules can be stored in a non-transitory readable storage medium. The above software function modules are stored in a storage medium and includes several instructions for causing an electronic device (which can be a personal computer, a dual-screen device, or a network device) or a processor to execute the method described in various embodiments in the present disclosure.

The selection module 201 selects a next to be executed thread.

In an embodiment, when an interrupt service is end or a system is called, a scheduler is started to schedule threads for execution of tasks, and the scheduler selects the next to be executed thread.

The determination module 202 determines whether a thread currently being executed is a highest priority thread. If the thread currently being executed is determined to be the highest priority thread. If the thread currently being executed is determined not the highest priority thread.

In a process of thread scheduling by the scheduler, the next to be executed thread can be selected according to priorities of the thread. The priorities can be set as a parameter available for scheduling by the scheduler. In an embodiment, by determining whether the thread currently being executed is the highest priority thread, it is determined whether the thread currently being executed is the selected thread. If the thread currently being executed is the highest priority thread, it is determined that the thread currently being executed is the selected thread. If the thread currently being executed is not the highest priority thread, it is determined that the thread currently being executed is not the selected thread.

The processing module 205 continues to execute the thread currently being executed.

In an embodiment, if the thread currently being executed is not the highest priority thread, execution of the thread currently being executed continues.

The processing module 205 stores contents in a current CPU register into a stack memory of the thread currently being executed.

Since a task of the thread currently being executed may not be completed, it is necessary to save execution progress of the thread when switching later, so that it can continue to run when switching back later. To give a simple example: for example, a thread A is reading contents of a file, and it has read half of the file, at this time, thread A needs to be suspended, and thread B is executed. When it is switched back to execute thread A again, thread A should not read again from a beginning of the file. Therefore, the contents of the thread currently being executed needs to be saved.

When a thread is in a process of being switched, it is necessary to save an Id, a thread state, a stack, states of registers, and other information of the current thread. The registers mainly include an SP, a PC, and an EAX registers. The SP is a stack pointer, pointing to a top address of a current stack. The PC is a program counter, which stores a next instruction to be executed. The EAX is an accumulation register, a default register for addition and multiplication.

In an embodiment, the contents of the current CPU register includes the stack pointer and the states of registers.

The determination module 202 determines whether the selected thread is a high-performance thread.

In an embodiment, one task may include a plurality of threads, and the plurality of threads may include a plurality of high-performance threads and some non-high-performance threads. A high-performance thread refers to a thread that accelerates local variable access during activities of the thread. Developers need to define which threads are high-performance threads during thread initialization. Specifically, when a thread is created, it is determined whether the created thread is a high-performance thread according to execution contents of the thread. When it is determined that the created thread is a high-performance thread, the created thread is marked as a high-performance thread, and the marked high-performance thread is added to a thread list. When it is determined that the created thread is a non-high-performance thread, the created thread is added to the thread list but is not marked.

In an embodiment, in determining whether the next to be executed thread is a high-performance thread, the selected thread is checked for a mark. If the selected thread has a mark, it is determined that the next to be executed thread is a high-performance thread. If the selected thread has no mark, it is determined that the next to be executed thread is a non-high-performance thread.

The processing module 205 stores contents of a stack memory of the selected thread into the CPU register.

When the selected thread is a non-high-performance thread, the contents of the selected thread (such as the PC, the SP, and the other registers, etc.) is copied from the stack memory of the selected thread to the CPU register, the on-chip memory is switched out.

The processing module 205 executes the selected thread.

In this embodiment, when it is confirmed that the selected thread is not a high-performance thread, the thread currently being executed and the selected thread are switched, and the selected thread is executed after the switching is completed.

The determination module 202 determines whether a thread-user of an on-chip memory is the selected high-performance thread.

In an embodiment, the thread-user of the on-chip memory refers to a target (for example, a thread) that is using the on-chip memory. When the selected thread is a high-performance thread, it is necessary to perform switching out of the selected thread through the on-chip memory. However, before switching, it is necessary to first determine whether the thread-user of the on-chip memory is the selected high-performance thread. That is to say, it is necessary to first determine whether the on-chip memory is being used by the selected high-performance thread.

The processing module 205 stores contents of the on-chip memory in the CPU register.

In an embodiment, when the thread-user of the on-chip memory is the selected high-performance thread (that is, the selected high-performance thread is using the on-chip memory), the contents of the on-chip memory are directly stored in the CPU register, the on-chip memory is switched out, and then the selected high-performance thread is executed.

The backup module 203 backs up contents of the on-chip memory to a stack memory of a thread corresponding to the thread-user.

In an embodiment, when the thread-user of the on-chip memory is not the selected high-performance thread, the contents of the on-chip memory needs to be backed up to the stack memory of the thread corresponding to the thread-user of the current on-chip memory. It should be noted that each thread has its own stack memory. In order to ensure that data is not lost, the contents of the on-chip memory needs to be backed up to the stack memory of the thread corresponding to the thread-user (the thread that is using the on-chip memory).

The backup module 203 backs up the contents of the stack memory of the selected thread to the on-chip memory.

In an embodiment, the on-chip memory is small and high-speed, and can be used as a stack memory shared by a plurality of threads. When the selected thread is a high-performance thread, the on-chip memory is required for execution, which can speed up data access. After the contents of the on-chip memory is backed up to the stack memory of the thread corresponding to the thread-user, the contents of the selected thread is loaded into the on-chip memory to process the selected thread through the on-chip memory thread.

The updating module 204 updates the thread-user of the on-chip memory to indicate the selected thread.

In an embodiment, after backing up the contents of the stack memory of the selected thread to the on-chip memory, it is also necessary to update the using of the on-chip memory by the selected thread. The contents of the on-chip memory is stored in the CPU register, the on-chip memory is switched out, and then the selected thread is executed.

In an embodiment, an occupancy parameter of the on-chip memory may be updated to a parameter corresponding to the selected thread.

In an embodiment, the on-chip memory includes an occupancy parameter, and the occupancy parameter corresponds to a thread. After the contents of the selected thread is loaded into the on-chip memory, the occupancy parameter of the on-chip memory is updated to the parameter corresponding to the selected thread to indicate that the on-chip memory is occupied by the selected thread.

For example, if the thread currently being executed C is a non-high-performance thread, and the next to be executed thread N is a high-performance thread, first determine whether the current thread-user P of the on-chip memory is a high-performance thread. If the current thread-user P of the on-chip memory is a high-performance thread, the contents of the on-chip memory needs to be stored in the CPU register, the on-chip memory is switched out. If the current thread-user P of the on-chip memory is a non-high-performance thread, the contents of the on-chip memory needs to be backed up to the stack memory of the thread corresponding to the thread-user P first. Then the contents of the stack memory of thread N is backed up to the on-chip memory, and the thread-user of the on-chip memory is updated to the thread N, and then the contents of the on-chip memory is stored in the CPU register, the on-chip memory is switched out. In this way, it is possible to select whether to execute the thread through the on-chip memory according to a type of thread. For example, when the type of thread is a high-performance thread, it can be executed through the on-chip memory. On-chip memory has a characteristic of high-speed processing, and this will accelerate and speed up data processing.

The embodiment also provides a non-transitory readable storage medium having computer-readable instructions stored therein. The computer-readable instructions are executed by a processor to implement the steps in the above-mentioned data processing method, such as in steps in blocks S1-S12 shown in FIG. 1:

The computer-readable instructions are executed by the processor to realize the functions of each module/unit in the above-mentioned device embodiments, such as the modules 201-205 in FIG. 2:

The selection module 201 selects a next to be executed thread;

The determination module 202 determines whether a thread currently being executed is a highest priority thread;

The determination module 202 determines whether a thread-user of an on-chip memory is the selected high-performance thread, if the selected thread is determined to be a high-performance thread;

The backup module 203 backs up contents of the on-chip memory to a stack memory of a thread corresponding to the thread-user, if the thread-user of the on-chip memory is determined not the selected high-performance thread;

The backup module 203 backs up contents of a stack memory of the selected thread to the on-chip memory;

The updating module 204 updates the thread-user of the on-chip memory to indicate the selected thread.

The processing module 205 stores the contents of the on-chip memory in a CPU register, and switches out the on-chip memory;

The processing module 205 executes the selected thread.

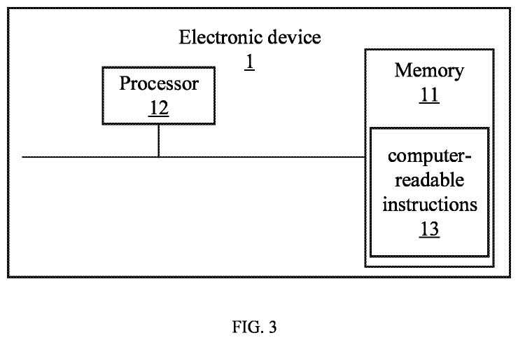

FIG. 3 is a schematic structural diagram of an electronic device provided in an embodiment of the present disclosure. The electronic device 1 may include: a memory 11, at least one processor 12, and computer-readable instructions 13 stored in the memory 11 and executable on the at least one processor 12, for example, data processing programs. The processor 12 executes the computer-readable instructions 13 to implement the steps in the embodiment of the data processing method, such as in steps in block S1-S12 shown in FIG. 1. Alternatively, the processor 12 executes the computer-readable instructions 13 to implement the functions of the modules/units in the foregoing device embodiments, such as the modules 201-205 in FIG. 2.

For example, the computer-readable instructions 13 can be divided into one or more modules/units, and the one or more modules/units are stored in the memory 11 and executed by the at least one processor 12. The one or more modules/units can be a series of computer-readable instruction segments capable of performing specific functions, and the instruction segments are used to describe execution processes of the computer-readable instructions 13 in the electronic device 1. For example, the computer-readable instruction can be divided into the selection module 201, the determination module 202, the backup module 203, the updating module 204, and the processing module 205 as in FIG. 2.

The electronic device 1 can be an electronic device such as a desktop computer, a notebook, a palmtop computer, and a cloud server. Those skilled in the art will understand that the schematic diagram 3 is only an example of the electronic device 1 and does not constitute a limitation on the electronic device 1. Another electronic device 1 may include more or fewer components than shown in the figures or may combine some components or have different components. For example, the electronic device 1 may further include an input/output device, a network access device, a bus, and the like.

The at least one processor 12 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 12 can be a microprocessor or any conventional processor. The processor 12 is a control center of the electronic device 1 and connects various parts of the entire electronic device 1 by using various interfaces and lines.

The memory 11 can be configured to store the computer-readable instructions 13 and/or modules/units. The processor 12 may run or execute the computer-readable instructions 13 and/or modules/units stored in the memory 11 and may call up data stored in the memory 11 to implement various functions of the electronic device 1. The memory 11 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the electronic device 1. In addition, the memory 11 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the electronic device 1 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A data processing method, the method comprising:
selecting a next to be executed thread;
determining whether the selected thread is a high-performance thread;
determining whether a thread-user of an on-chip memory is the selected high-performance thread, if the selected thread is determined to be a high-performance thread;
backing up contents of the on-chip memory to a stack memory of a thread corresponding to the thread-user, if the thread-user of the on-chip memory is determined not the selected high-performance thread;
backing up contents of a stack memory of the selected thread to the on-chip memory;
updating the thread-user of the on-chip memory to indicate the selected thread;
storing the contents of the on-chip memory in a CPU register, and switching out the on-chip memory; and
executing the selected thread.

2. The data processing method according to claim 1, the method further comprising:
storing the contents of the stack memory of the selected thread into the CPU register, switching out the on-chip memory, if the selected thread is determined not a high-performance thread; and
executing the selected thread.

3. The data processing method of claim 2, the method further comprising:
storing the contents of the on-chip memory into the CPU register, switching out the on-chip memory, if the thread-user of the on-chip memory is determined to be the selected high-performance thread; and
executing the selected thread.

4. The data processing method of claim 1, after selecting the next to be executed thread, the method further comprising:
determining whether a thread currently being executed is a highest priority thread;
storing contents in a current CPU register into a stack memory of the thread currently being executed, if the thread currently being executed is determined not the highest priority thread; and
continuing to execute the current thread, if the thread currently being executed is determined to be the highest priority thread.

5. The data processing method of claim 4, the method of determining whether the thread currently being executed is the highest priority thread comprising:
determining whether the next to be executed thread is a high-performance thread by checking whether the selected thread has a mark;
determining that the next to be executed thread is a high-performance thread, if the selected thread has a mark;
determining that the next to be executed thread is a non-high-performance thread, if the selected thread has no mark.

6. The data processing method according to claim 1, by updating an occupancy parameter of the on-chip memory to a parameter corresponding to the selected thread, the thread-user of the on-chip memory is updated to indicate the selected thread.

7. The data processing method according to claim 1, wherein the high-performance thread refers to a thread that accelerates local variable access during activities of the thread.

8. A electronic device comprising a memory and a processor, the memory stores at least one computer-readable instruction, and the processor executes the at least one computer-readable instruction to implement to:
select a next to be executed thread;
determine whether the selected thread is a high-performance thread;
determine whether a thread-user of an on-chip memory is the selected high-performance thread, if the selected thread is determined to be a high-performance thread;
back up contents of the on-chip memory to a stack memory of a thread corresponding to the thread-user, if the thread-user of the on-chip memory is determined not the selected high-performance thread;
back up contents of a stack memory of the selected thread to the on-chip memory;
update the thread-user of the on-chip memory to indicate the selected thread;
store the contents of the on-chip memory in a CPU register, and switch out the on-chip memory; and
execute the selected thread.

9. The electronic device according to claim 8, wherein the processor further to:
store the contents of the stack memory of the selected thread into the CPU register, switch out the on-chip memory, if the selected thread is determined not a high-performance thread; and
execute the selected thread.

10. The electronic device according to claim 9, wherein the processor further to:
store the contents of the on-chip memory into the CPU register, switch out the on-chip memory, if the thread-user of the on-chip memory is determined to be the selected high-performance thread; and
execute the selected thread.

11. The electronic device according to claim 8, after selecting the next to be executed thread, wherein the processor further to:
determine whether a thread currently being executed is a highest priority thread;
store contents in a current CPU register into a stack memory of the thread currently being executed, if the thread currently being executed is determined not the highest priority thread;
continue to execute the current thread, if the thread currently being executed is determined to be the highest priority thread.

12. The electronic device according to claim 11, the processor determining whether the thread currently being executed is the highest priority thread by:
determining whether the next to be executed thread is a high-performance thread by checking whether the selected thread has a mark;
determining that the next to be executed thread is a high-performance thread, if the selected thread has a mark;
determining that the next to be executed thread is a non-high-performance thread, if the selected thread has no mark.

13. The electronic device according to claim 8, by updating an occupancy parameter of the on-chip memory to a parameter corresponding to the selected thread, the thread-user of the on-chip memory is updated to indicate the selected thread.

14. The electronic device according to claim 8, wherein the high-performance thread refers to a thread that accelerates local variable access during activities of the thread.

15. A non-transitory storage medium having stored thereon at least one computer-readable instructions that, when the at least one computer-readable instructions are executed by a processor to implement the following steps:
selecting a next to be executed thread;
determining whether the selected thread is a high-performance thread;
determining whether a thread-user of an on-chip memory is the selected high-performance thread, if the selected thread is determined to be a high-performance thread;
backing up contents of the on-chip memory to a stack memory of a thread corresponding to the thread-user, if the thread-user of the on-chip memory is determined not the selected high-performance thread;
backing up contents of a stack memory of the selected thread to the on-chip memory;
updating the thread-user of the on-chip memory to indicate the selected thread;
storing the contents of the on-chip memory in a CPU register, and switching out the on-chip memory; and
executing the selected thread.

16. The non-transitory storage medium according to claim 15, the method further comprising:
storing the contents of the stack memory of the selected thread into the CPU register, switching out the on-chip memory, if the selected thread is determined not a high-performance thread; and
executing the selected thread.

17. The non-transitory storage medium according to claim 16, the method further comprising:
storing the contents of the on-chip memory into the CPU register, switching out the on-chip memory, if the thread-user of the on-chip memory is determined to be the selected high-performance thread; and
executing the selected thread.

18. The non-transitory storage medium according to claim 15, after selecting the next to be executed thread, the method further comprising:
determining whether a thread currently being executed is a highest priority thread;
storing contents in a current CPU register into a stack memory of the thread currently being executed, if the thread currently being executed is determined not the highest priority thread;
continuing to execute the current thread, if the thread currently being executed is determined to be the highest priority thread.

19. The non-transitory storage medium according to claim 18, the method of determining whether the thread currently being executed is the highest priority thread comprising:
determining whether the next to be executed thread is a high-performance thread by checking whether the selected thread has a mark;
determining that the next to be executed thread is a high-performance thread, if the selected thread has a mark;
determining that the next to be executed thread is a non-high-performance thread, if the selected thread has no mark.

20. The non-transitory storage medium according to claim 15, by updating an occupancy parameter of the on-chip memory to a parameter corresponding to the selected thread, the thread-user of the on-chip memory is updated to indicate the selected thread.
